(19) United States
(12) Patent Application Publication
(10) Pub. No.: US 2004/0035983 A1
(43) Pub. Date: Feb. 26, 2004

(54) Adjustable cable restraint

(76) Inventors: Kenneth C. Simonson, Arlington, TX (US); William B. Stone, Keller, TX (US)

Correspondence Address: CORNING CABLE SYSTEMS LLC, P O BOX 489, HICKORY, NC, 28603, US

(21) Appl. No.: 10/227,097

(22) Filed: Aug. 26, 2002

(51) Int. Cl. F16L 3/00

(52) U.S. Cl. 248/49

(57) ABSTRACT

A cable restraint for a telecommunications equipment frame includes mounting brackets adapted for mounting to the frame, a cross bar, and an adjustment mechanism connecting the cross bar to the mounting brackets. In one embodiment, the cable restraint further includes arms spaced apart by the cross bar and depending therefrom. Each mounting bracket has a first end adjacent the frame, a second end spaced from the first end and the frame, and a slot formed therethrough that extends between the first end and the second end. Each arm has an externally threaded stud that engages the slot such that the position of the cross bar relative to the mounting bracket and the frame is adjustable between a retracted position at a first predetermined distance from the first ends of the mounting brackets and an extended position at a second predetermined distance from the first ends of the mounting brackets.

### FIELD OF THE INVENTION

The invention relates generally to a cable restraint for supporting and strain relieving a cable, and more particularly, to an adjustable cable restraint for supporting and strain relieving a cable at various distances from a rack-mountable telecommunications frame.

### BACKGROUND OF THE INVENTION

The demand for increased communications bandwidth requires the use of higher density equipment shelves, for example xDSL (digital subscriber line) splitter shelves, on a rack-mountable telecommunications frame. One solution for achieving higher density is to reduce the height of each splitter shelf so that a greater number of such shelves can be utilized on a given telecommunications frame. Prior equipment shelves are designed with sufficient height to permit cables ties to be provided on the outer surface of the backplate. As a result, tie wraps can be threaded through the cable ties to secure cables, such as jumper cables, directly to the shelf. The reduced height of higher density equipment shelves, however, does not permit cable ties to be provided on the backplate. Accordingly, any support and/or strain relief needed for the cables must be provided on the frame in which the higher density equipment shelf is installed.

There are many suppliers of telecommunications frames that provide apparatus for supporting and/or strain relieving cables on the frame. Such apparatus are generically referred to herein as “cable restraints.” Unfortunately, each of the previously known cable restraints supports and/or strain relieves one or more cables only at a fixed distance from the frame. An example of a prior cable restraint available from Newton Instrument Company, Inc. of Butner, N.C., is illustrated in FIGS. 1 and 2. The cable restraint, indicated generally at 10, is formed from a length of round bar stock material, such as steel, into a cross bar 12 and a pair of mounting arms 14 depending from the cross bar 12. The cross bar 12 has a preselected length corresponding to the width of the frame and the mounting arms 14 have equal lengths, such as 2 inches, 4 inches, 6 inches, etc., that are selected so that the cross bar 12 extends outwardly a predetermined distance from the frame. The free end of each of the mounting arms 14 is bent into a “U-shaped” mount 16 that is parallel to the cross bar 12. The mounts 16 receive suitable fasteners, such as threaded bolts (not shown), to secure the cable restraint 10 to a rack-mountable telecommunications frame. Once the cable restraint 10 is secured to the frame, a tie wrap (not shown) may be positioned around the cross bar 12 and a cable (not shown) and the tie wrap tightened in a known manner to strain relieve the cable to the cable restraint 10.

Existing cable restraints 10 are manufactured with cross bars 12 of different lengths that are sized to span telecommunications frames having various standard widths. Depending on the equipment shelf to be mounted on the frame, and in particular on the distance that the equipment shelf extends outwardly from the frame, the installer selects a cable restraint 10 having a standard length cross bar 12 corresponding to the width of the frame and mounting arms 14 of a suitable length. A serious limitation imposed by the cable restraint 10, however, is that different cable restraints 10 are required for use with equipment shelves that extend different distances outwardly from the frame. Thus, the installer must determine how far the equipment shelf will extend outwardly from the frame in order to select and purchase a cable restraint 10 having the proper length mounting arms 14. The problem is compounded when there is a need for several equipment shelves that extend outwardly different distances to be installed on the same frame. Furthermore, in the event that the frame is subsequently reconfigured with one or more equipment shelves that extend outwardly a different distance from the frame, the cable restraint 10 will have to be removed and replaced with a cable restraint 10 having the proper length mounting arms 14. For a given cable restraint 10, the horizontal distance of the cross bar 12 from the frame is not adjustable. Thus, the installer is limited to using a cable restraint 10 having mounting arms 14 of the predetermined lengths available from the manufacturer. As a result, there can be too little, or possibly too much, cable between the cross bar 12 and the frame, thereby compromising the integrity of cable management on the frame.

It is apparent a cable restraint for supporting and/or strain relieving a cable on a telecommunications frame is needed that may be used with equipment shelves that extend outwardly different distances from the frame. It is further apparent a cable restraint for supporting and/or strain relieving a cable on a telecommunications frame is needed that may be used with equipment shelves that extend outwardly different distances from the frame. It is further apparent a cable restraint for a telecommunications frame reconfigured with one or more equipment shelves that extend outwardly a different distance from the frame is needed so that it is not necessary to remove and replace the cable restraint. It is particularly apparent a cable restraint for supporting and/or strain relieving a cable on a telecommunications frame is needed wherein the distance of the cross bar from the frame is adjustable.

### SUMMARY OF THE INVENTION

In one embodiment, the invention is a cable restraint including at least one mounting bracket adapted for mounting to a frame, a cross bar and an adjustment mechanism connecting the cross bar to the mounting bracket. The adjustment mechanism connects the cross bar to the mounting bracket such that the position of the cross bar relative to the mounting bracket and the frame is adjustable. Preferably, the adjustment mechanism includes a slot formed in the mounting bracket and a stud attached to the cross bar that is received within the slot. A fastener engages the stud against the mounting bracket to secure the cross bar to the mounting bracket at a desired distance from the frame. The cross bar may include at least one cable tie for receiving a cable wrap to secure a cable to the cross bar at the desired distance from the frame.

In the particular embodiment shown and described herein, the cable restraint includes a mounting bracket having a first end adapted for mounting to a frame and a second end spaced apart from the first end and the frame. The cable restraint further includes a cross bar connected to the mounting bracket and an adjustment mechanism for adjusting the position of the cross bar relative to the mounting bracket. The cross bar includes a support member and at least one mounting arm depending therefrom. The adjustment mechanism preferably includes a slot formed through the mounting bracket and a stud depending from the mounting arm and positioned within the slot. A fastener engages the stud to releasably secure the cross bar to the mounting bracket. The mounting arm is slidable horizontally within the slot such that the cross bar is adjustable between a retracted position wherein the cross bar is a first predetermined distance from the first end of the mounting bracket and an extended position wherein the cross bar is a second predetermined distance from the first end of the mounting bracket. The mounting arm further has a protrusion attached thereto that is received within the slot to prevent rotation of the cross bar relative to the mounting bracket. The support member may include at least one cable tie for receiving a cable wrap to secure a cable to the cross bar at a desired distance from the frame.

### BRIEF DESCRIPTION OF THE DRAWINGS

The accompanying drawings, which are incorporated in and constitute a part of this specification, provide further understanding of the invention, illustrate various embodiments of the invention, and together with the following detailed description, help to fully explain the principles and objectives thereof. The invention will be described more fully hereinafter in conjunction with the drawings, wherein like reference numerals represent the same or similar parts in the different views, and in which:

FIG. 1 is a plan view of a prior art cable restraint;

FIG. 2 is an elevation view of the prior art cable restraint of FIG. 1;

FIG. 3 is a perspective view of a preferred embodiment of a cable restraint constructed in accordance with the present invention;

FIG. 4 is a plan view of the mounting bracket of the cable restraint of FIG. 3;

FIG. 5 is an elevation view of the mounting bracket of the cable restraint of FIG. 3;

FIG. 6 is a side view of the mounting bracket of the cable restraint of FIG. 3;

FIG. 7 is a plan view of the cross bar of the cable restraint of FIG. 3;

FIG. 8 is an elevation view of the cross bar of the cable restraint of FIG. 3;

FIG. 9 is a side view of the cross bar of the cable restraint of FIG. 3;

FIG. 10 is a perspective view of a rack-mountable telecommunications frame having an equipment shelf and a cable restraint according to the invention mounted thereon; and

FIG. 11 is a side view of the telecommunications frame of FIG. 10 having equipment shelves and cable restraints according to the invention mounted thereon that extend outwardly different distances from the frame; and

FIG. 12 is a rear elevation view of the telecommunications frame of FIG. 11.

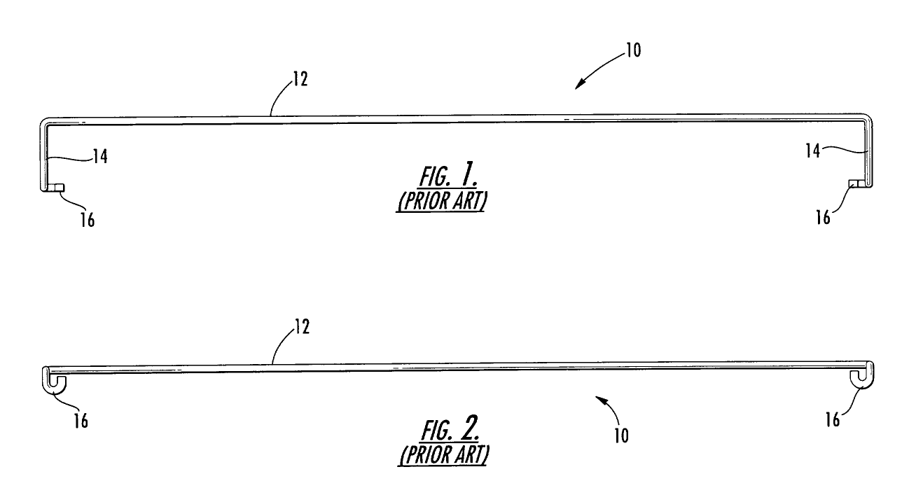

### DETAILED DESCRIPTION OF PREFERRED EMBODIMENTS OF THE INVENTION

The invention will now be described with reference to the accompanying drawings, in which a preferred embodiment of the invention is shown. The invention may, however, be embodied in many different forms, and therefore, should not be construed as being limited to the embodiment described and shown herein. An illustrative embodiment is set forth herein so that this description will be thorough and complete, and will fully convey the intended scope of the claimed invention while enabling those skilled in the art to make and practice the invention without undue experimentation. Relative terms, such as horizontal, vertical, front, rear, top, bottom, side, outwardly, inwardly, etc. are used herein for purposes of clarity and explanation only, and thus, are not to be construed as limiting the scope of the invention as set forth in the claims appended hereto in any manner.

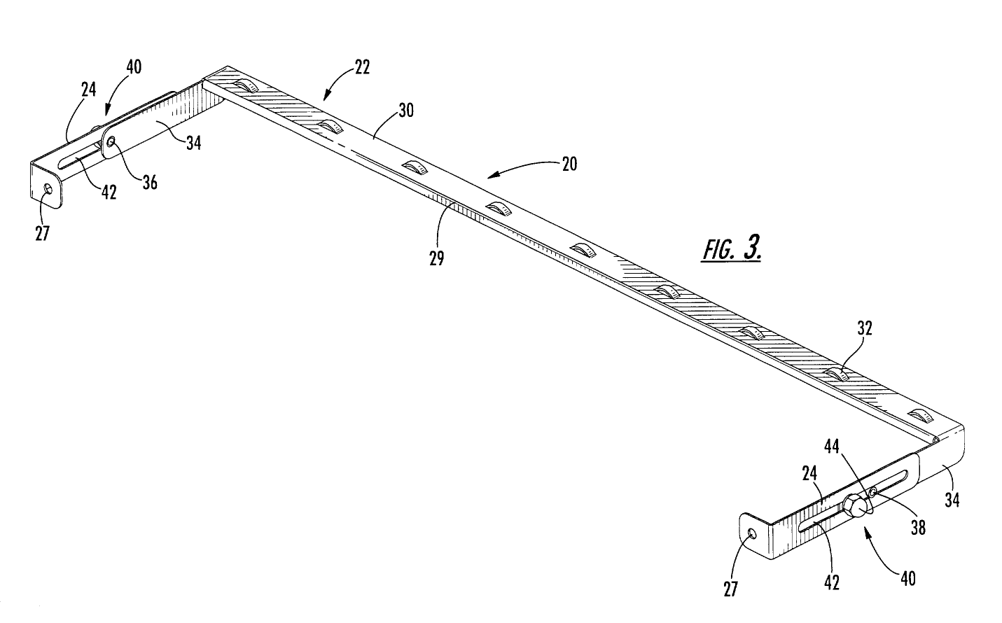

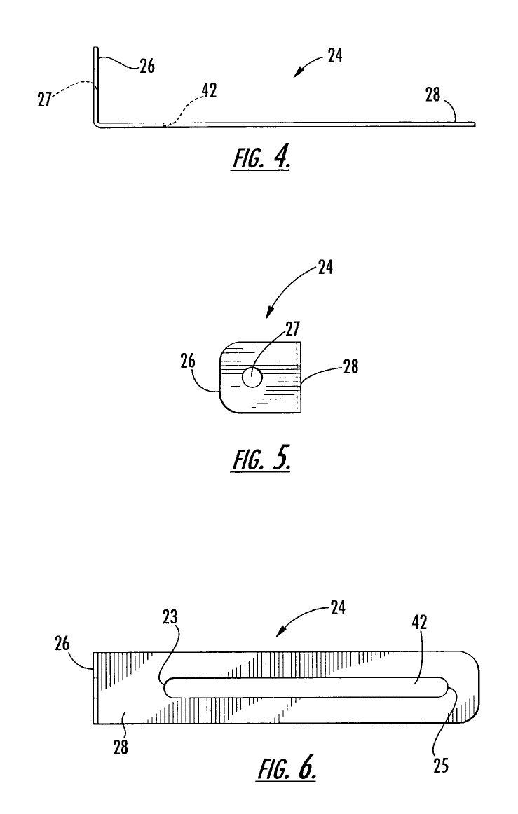

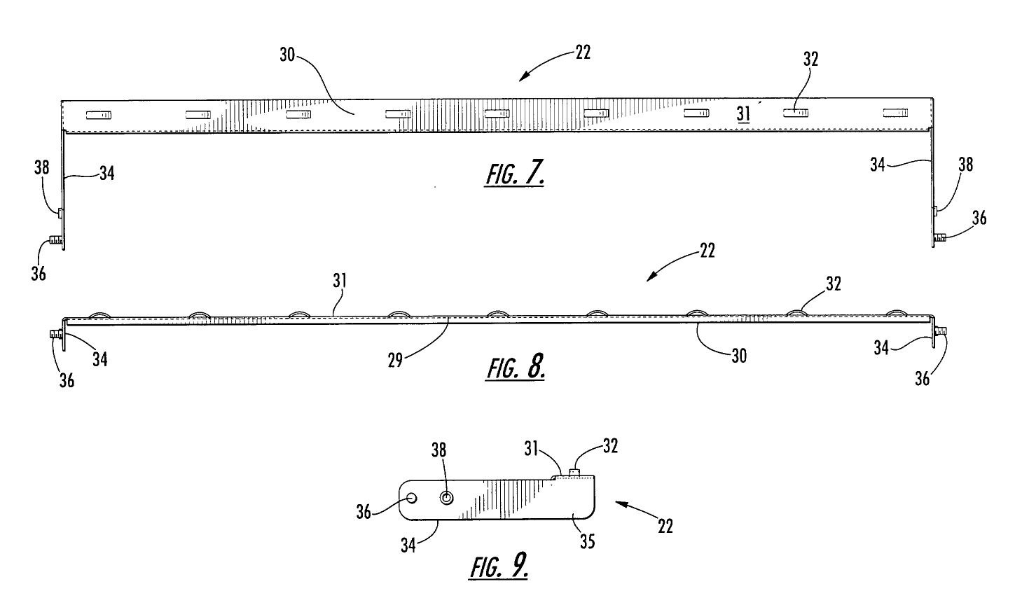

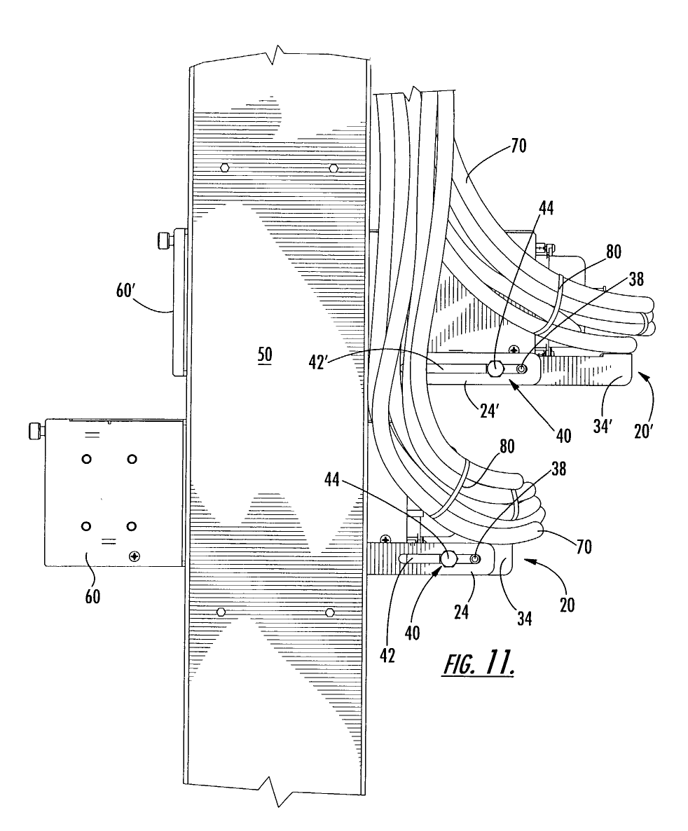

Referring now to the figures, FIG. 3 shows a cable restraint, indicated generally at 20, constructed in accordance with the present invention for supporting and/or strain relieving a cable on a telecommunications frame. FIGS. 4-6 show the mounting bracket, indicated generally at 24, of the cable restraint 20. FIGS. 7-9 show the cross bar, indicated generally at 22, of the cable restraint 20. FIG. 10 shows the cable restraint 20 and a typical equipment shelf 60 mounted on a rack-mountable telecommunication frame 50. FIGS. 11 and 12 show equipment shelves 60 and cable restraints 20 mounted on the telecommunications frame 50 such that the cable restraints 20 extend outwardly different distances from the frame 50. Communications and power cables, collectively referred to herein as cables 70, are routed to and from other frames 50 and between different equipment shelves 60. As used herein, the term “cable” includes any tangible means for transmitting communications signals or power, such as fiber optic cable or electrical (e.g., copper) cable. For example, cables 70 may be jumper cables routed between equipment shelves 60 on the same frame 50, or on different frames 50. In certain instances, and in particular for higher density applications, the equipment shelves 60 are of insufficient height to permit cable ties to be provided on the backplate 62 (FIGS. 10 and 12) of the equipment shelf 60. As a result, it is necessary to utilize a cable restraint 20 that attaches directly to the frame 50. In some cases, one or more cables 70 need only be supported on the frame 50, and thus, are loosely secured to the cable restraint 20 with, for example, conventional tie wraps 80 (FIGS. 10-12). In other cases, one or more cables 70 must be strain relieved, and thus, are tightly secured to the cable restraint 20 with the tie wraps 80, as will be described hereinafter.

In the exemplary embodiment shown in the figures, cable restraint 20 comprises a cross bar 22 and a pair of mounting brackets 24 adapted for mounting the cable restraint 20 to the frame 50. In an alternative embodiment, however, the cable restraint 20 may comprise a cross bar 22 and only a single mounting bracket 24, each having sufficient stiffness such that the cable restraint 20 may be cantilevered from the frame 50 without excessive flexure. The mounting bracket 24 may be adapted for mounting to the frame 50 in any conventional manner. As best shown in FIGS. 4-6, the mounting bracket 24 is “L-shaped” and comprises a flange 26 having an opening 27 therethrough. The opening 27 receives a fastener, for example an externally threaded bolt (not shown), that engages an internally threaded hole 52 (FIGS. 10 and 11) on the frame 50 to secure the mounting bracket 24 to the frame 50 at a suitable location relative to the corresponding equipment shelf 60. Various alternative means for securing the mounting bracket 24 to the frame 50 are well known, and thus, the means described herein should not be construed to limit the scope of the invention in any manner. The mounting bracket 24 further comprises a leg 28 that depends outwardly from flange 26, and thus, from frame 50 when mounting bracket 24 is mounted on frame 50. As shown, leg 28 depends substantially perpendicular from flange 26. However, leg 28 may depend from flange 26 at any suitable angle depending on space limitations and design constraints imposed on the frame 50. The cable restraint 20 further comprises an adjustment mechanism, indicated generally at 40. The adjustment mechanism 40 connects the cross bar 22 to the mounting bracket 24 such that the position of the cross bar 22 relative to the mounting bracket 24 and the frame 50 is adjustable, as will be described hereinafter.

The cross bar 22 is made of a thin, relatively stiff material, and preferably, is made of a metal, such as steel, that can be easily formed from a sheet of flat stock. As best shown in FIGS. 7-9, the cross bar 22 comprises an elongate, generally rectangular, support member 30 that is about equal in length to the width of the frame 50. Preferably, the support member 30 is formed in various lengths that correspond to the standard widths of commercially available telecommunications frames 50. For example, the length of the support member 30 may be about 19.5 inches or about 23.5 inches. However, the length of the support member 30 may be made any desired length depending on space limitations and design constraints imposed on the frame 50. As illustrated in FIGS. 10-12, one or more cables 70 entering or exiting an equipment shelf 60 on the frame 50 may be positioned, and thereby supported, on the support member 30. Preferably, the inner edge 29 of the support member 30 is bent downwardly to present a smooth surface to protect the cables 70 entering onto or exiting from the upper surface 31 of the equipment shelf 60. As shown, the support member 30 may also be provided with one or more cable ties 32 on the upper surface 31 of the support member 30. The cable ties 32 may be formed on or affixed to the upper surface 31 of the support member 30, in any suitable manner. As shown herein, the cable ties 32 are formed by cutting parallel, lengthwise slits through the support member 30 and punching the material between the slits from the underside of the support member. The manufacturing process for forming the cable ties 32 on the upper surface 31 of the support member 30 is often referred to in the art as “lancing.” Accordingly, the cable ties 32 may also be referred to as “lances.” The cable ties 32 provide locations for cable wraps 80 to be threaded between the cable tie 32 and the upper surface 31 of the support member 30. The cable wrap 80 is then wrapped around the cable 70 and pulled against the cable tie 32 in a known manner to secure the cable 70 on the support member 30. If pulled tightly against the cable tie 32, the cable 70 is both supported and strain relieved on the support member 30.

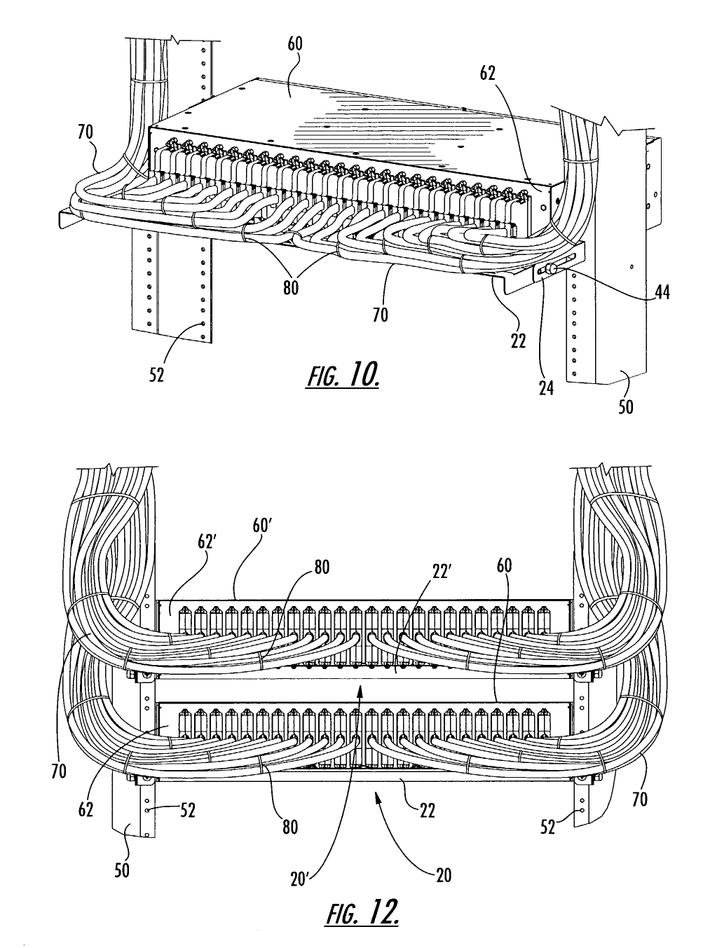

In the exemplary embodiment shown herein, the cross bar 22 further comprises a least one, and preferably, a pair of mounting arms 34. The mounting arms 34 are spaced apart along the length of the support member 30 and depend outwardly therefrom. As shown herein, the mounting arms 34 depend substantially perpendicular from the support member 30. The mounting arms 34, however, may depend from the support member 30 at any suitable angle depending on space limitations and design constraints imposed on the frame 50. Preferably, the mounting arms 34 are formed by bending the ends of the support member 30 downwardly away from the upper surface 31 such that the outer surface 35 (FIG. 9) of the mounting arms 34 faces outwardly from the support member 30. As best shown in FIGS. 7 and 8, an externally threaded stud 36 is attached, for example by welding, to the cross bar 22 adjacent the free end of each mounting arm 34. The stud 36 extends outwardly from the mounting arm 34 and cooperates with the corresponding mounting bracket 24 to adjustably connect the cross bar 22 to the mounting bracket 24, as will be described. An outwardly extending protrusion 38 may also be provided on each mounting arm 34 for a purpose to be described hereinafter. Preferably, the protrusion 38 is positioned on the mounting arm 34 medially between the support member 30 and the stud 36. However, the protrusion 38 may extend outwardly from any convenient location on the mounting arm 34. As shown and described herein, the cross bar 22 comprises a pair of mounting arms 34. However, the cross bar 22 may comprise only one mounting arm 34, for example when the cross bar 22 and a single mounting bracket 24 are cantilevered from the frame 50, or may comprise no mounting arms 34 at all. In the event that the mounting arms 34 are eliminated, the support member 30 may be provided with an outwardly extending stud 38 at each end for cooperating with the mounting bracket 24 in the manner described hereinafter. Use of the mounting arms 34 is desirable, however, so that the mounting brackets 24 do not extend beyond the support member 30 and thereby possibly interfere with routing the cables 70, or present a potential hazard to personnel working in the vicinity of the frame 50.

As previously mentioned, the cable restraint 20 further comprises an adjustment mechanism 40 connecting the cross bar 22 to each mounting bracket 24. The adjustment mechanism 40 may be any means for connecting the cross bar 22 to the mounting bracket 24 such that the position of the cross bar 22 relative to the mounting bracket 24 and the frame 50 is adjustable. As shown and described herein, the means for connecting (i.e., adjustment mechanism 40) comprises the stud 36 extending outwardly from mounting arm 34 and an elongate slot 42 formed in the mounting bracket 24. The slot 42 extends lengthwise on the mounting bracket 24 from a first end 23 adjacent the flange 26 to a second end 25 opposite the first end 23. The slot 42 is sized to receive the stud 36, and if provided, the protrusion 38 therein with a slight loose fit such that the stud 36 and the protrusion 38 are substantially free to slide horizontally within the slot 42. The stud 36 may be positioned anywhere along the length of the slot 42 between the first end 23 and the second end 25 so that the cross bar 22 is positioned at a desired distance from the flange 26 of the mounting bracket 24, and thus, at a desired distance from the frame 50. The desired position of the cross bar 22 relative to the mounting bracket 24 and the frame 50 may be fixed by securing the mounting arm 34 to the mounting bracket 24 with a suitable fastener 44, for example a conventional wing nut or acorn nut, on the stud 36. The stud 36 and the protrusion 38 combine to prevent rotation of the cross bar 22 relative to the mounting bracket 24 when the cable restraint 20 is mounted to the frame 50 and one or more cables 70 are supported and/or strain relieved on the support member 30. However, the mounting arm 34 may be manufactured without protrusion 38, or protrusion 38 may be removed, for example by grinding, in the event that rotation of the cross bar 22 relative to the mounting bracket 24 is desired. Such rotation may be desired to angle the cross bar 22 upwardly or downwardly relative to the mounting bracket 24 and thereby provide additional spacing between the cable restraints 20 of adjacent equipment shelves 60. Typically, however, it will be desirable to maintain the mounting arm 34 substantially parallel to the mounting bracket 24 and substantially perpendicular to the frame 50 such that the upper surface 31 of the support member 30 remains horizontal. As a result, the cables 70 will lie relatively flat when supported on the support member 30 and/or secured by the tie wraps 80. In the event that the cross bar 22 does not comprise mounting arms 34 or protrusions 38, the stud 36 on the end of the support member 30 may be made square instead of round. As a result, the stud 36 engages the slot 42 to prevent rotation while still permitting horizontal movement of the cross bar 22 relative to the mounting bracket 24.

The adjustment mechanism 40 shown and described herein is only one example of a suitable means for adjustably connecting the cross bar 22 to the mounting bracket 24. Numerous other embodiments of means for connecting the cross bar 22 to the mounting bracket 24 are equally acceptable and functionally equivalent. By way of further example, and without limitation, means 40 may comprise an elongate slot having a saw-tooth shaped lower surface that receives the stud 36 therein at multiple predetermined positions between the first end 23 and the second end 25. Alternatively, the leg 28 of the mounting bracket 24 may be provided with rounded edges and the mounting arm 34 may be formed with a hollow interior and sized to overlie the mounting bracket 24 such that the mounting arm 34 slides horizontally along the length of the mounting bracket 24. A threaded hole may also be formed through the mounting arm 34 and a set screw provided to secure the mounting arm 34 at any position along the length of the mounting bracket 24. Alternatively, means 40 may comprise a ball biased on the mounting arm 34 (for example by a spring) that engages detents formed in the mounting bracket 24 at multiple predetermined positions between the first end 23 and the second end 25. Functionally, means 40 may comprise any mechanism that connects the cross bar 22 to the mounting bracket 24 such that the position of the cross bar 22 relative to the mounting bracket 24 and the frame 50 is adjustable. In particular, means 40 may comprise any mechanism that permits the cross bar 22 to be adjusted (i.e., moved) between a retracted position wherein the cross bar 22 is a first predetermined distance from the frame 50, and an extended position wherein the cross bar 22 is a second predetermined distance from the frame 50. Furthermore, the functionality of the mounting arm 34 and the mounting bracket 24 may be reversed in any of the examples provided herein. For example, the slot 42 may be formed in the mounting arm 34, and the stud 36 and protrusion 38 provided on the mounting bracket 24. Similarly, the spring-biased ball may be provided on the mounting bracket 24 and the detents formed in the mounting arm 34. Preferably, adjustment mechanism 40 will be configured so as to be easily accessible from the sides of the frame 50 so that the position of the cross bar 22 may be adjusted without disturbing any cables 70 supported and/or strain relieved on the support member 30. The adjustment mechanism 40, however, may be configured in any manner depending on space limitations and design constraints imposed on the frame 50.

As previously mentioned, FIG. 10 illustrates an equipment shelf 60 and a cable restraint 20 constructed in accordance with the invention mounted on a rack-mountable telecommunications frame 50. The cross bar 22 of the cable restraint 20 is adjusted by securing nuts 44 on studs 36 against mounting bracket 24 such that the support member 30 is positioned at a desired distance from the frame 50 to support and strain relieve a plurality of cables 70 entering and exiting the backplate 62 of the equipment shelf 60. The cables 70 are supported on the support member 30 and strain relieved thereto using tie wraps 80 in a known manner. FIGS. 11 and 12 illustrate a first equipment shelf 60 mounted medially on frame 50 and a second equipment shelf 60′ flush-mounted on the frame 50 such that the first equipment shelf 60 protrudes forwardly of the second equipment shelf 60′ and the frame 50. As a result, the cross bar 22′ of the cable restraint 20′ corresponding to the second equipment shelf 60′ extends outwardly from the frame 50 a greater distance than the cross bar 22 of the cable restraint 20 corresponding to the first equipment shelf 60. Thus, the mounting bracket 24′ and the mounting arm 34′ of the cable restraint 20′ have greater lengths than the mounting bracket 24 and the mounting arm 34 of the cable restraint 20. The slot 42′ of mounting bracket 24′ may also be proportionally longer than the slot 42 of the mounting bracket 24. For example, the cable restraint 20 may be adjustable between a retracted position wherein the cross bar 22 is about 4 inches from the frame 50 and an extended position wherein the cross bar 22 is about 6 inches from the frame 50 to accommodate the equipment shelf 60. Similarly, the cable restraint 20′ may be adjustable between a retracted position wherein the cross bar 22′ is about 6 inches from the frame 50 and an extended position wherein the cross bar 22 is about 9 inches from the frame 50 to accommodate the equipment shelf 60′ that is flush-mounted to the frame 50. Accordingly, the cable restraints 20 and 20′ are adjustable to support and/or strain relieve cables 70 at a distance between about 4 and about 9 inches from the frame 50. Obviously, the size and the relationship of the various components of the cable restraint 20 can be modified such that the position of the cross bar 22 is adjustable to any desired distance from the frame 50.

Many modifications and other embodiments of the invention will come to mind to one skilled in the art to which this invention pertains having the benefit of the teachings presented in the foregoing descriptions and the associated drawings. Therefore, it is to be understood that the invention is not intended to be limited to the specific embodiments disclosed herein and that further modifications and other embodiments are intended to be included within the scope of the appended claims. Although specific terms are employed herein, they are used in a generic and descriptive sense only and not for purposes of limitation.

That which is claimed is:

1. A cable restraint comprising:
at least one mounting bracket adapted for mounting to a frame;
a cross bar; and
an adjustment mechanism connecting the cross bar to the mounting bracket such that the position of the cross bar relative to the mounting bracket and the frame is adjustable.

2. A cable restraint according to claim 1 wherein the adjustment mechanism comprises a slot formed in the mounting bracket and a stud attached to the cross bar that is received within the slot.

3. A cable restraint according to claim 2 further comprising a fastener that engages the stud against the mounting bracket to secure the cross bar to the mounting bracket at a desired distance from the frame.

4. A cable restraint according to claim 1 wherein the cross bar comprises at least one cable tie for receiving a cable wrap to secure a cable to the cross bar.

5. A cable restraint according to claim 1 wherein the cross bar comprises a support member and at least one mounting arm depending therefrom and wherein the adjustment mechanism comprises a slot formed in the mounting bracket and a stud attached to the mounting arm that is received within the slot.

6. A cable restraint according to claim 5 further comprising a fastener that engages the stud against the mounting bracket to secure the cross bar to the mounting bracket at a desired distance from the frame.

7. A cable restraint according to claim 5 wherein the mounting arm further has a protrusion attached thereto that is received within the slot to prevent rotation of the cross bar relative to the mounting bracket.

8. A cable restraint according to claim 5 wherein the support member comprises at least one cable tie for receiving a cable wrap to secure a cable to the cross bar.

9. A cable restraint comprising:
at least one mounting bracket adapted for mounting to a frame;
a cross bar; and
means for connecting the cross bar to the mounting bracket such that the position of the cross bar relative to the mounting bracket and the frame is adjustable.

10. A cable restraint according to claim 9 wherein the means for connecting comprises a slot formed in the mounting bracket and a stud attached to the cross bar that is received within the slot.

11. A cable restraint according to claim 10 further comprising a fastener that engages the stud against the mounting bracket to secure the cross bar to the mounting bracket at a desired distance from the frame.

12. A cable restraint according to claim 9 wherein the cross bar comprises at least one cable tie for receiving a cable wrap to secure a cable to the cross bar.

13. A cable restraint according to claim 9 wherein the cross bar comprises a support member and at least one mounting arm depending therefrom and wherein the adjustment mechanism comprises a slot formed in the mounting bracket and a stud attached to the mounting arm that is received within the slot.

14. A cable restraint according to claim 13 further comprising a fastener that engages the stud against the mounting bracket to secure the cross bar to the mounting bracket at a desired distance from the frame.

15. A cable restraint according to claim 13 wherein the mounting arm further has a protrusion attached thereto that is received within the slot to prevent rotation of the cross bar relative to the mounting bracket.

16. A cable restraint according to claim 13 wherein the support member comprises at least one cable tie for receiving a cable wrap to secure a cable to the cross bar.

17. A cable restraint comprising:
at least one mounting bracket having a first end adapted for mounting to a frame and a second end spaced from the first end and the frame;
a cross bar;
an adjustment mechanism connecting the cross bar to the mounting bracket such that the position of the cross bar relative to the mounting bracket and the frame is adjustable between a retracted position adjacent the first end of the mounting bracket and an extended position adjacent the second end of the mounting bracket.

18. A cable restraint according to claim 17 wherein the adjustment mechanism comprises a slot extending between the first end of the mounting bracket and the second end of the mounting bracket, a stud attached to the cross bar that is received within the slot, and a fastener that engages the stud against the mounting bracket to secure the cross bar to the mounting bracket at a desired distance from the frame.

19. A cable restraint according to claim 17 wherein the cross bar comprises at least one cable tie for receiving a cable wrap to secure a cable to the cross bar.

20. A cable restraint according to claim 17 wherein the cross bar comprises a support member and at least one mounting arm depending therefrom and wherein the adjustment mechanism comprises a slot extending between the first end of the mounting bracket and the second end of the mounting bracket, a stud attached to the mounting arm that is received within the slot, and a fastener that engages the stud against the mounting bracket to secure the cross bar to the mounting bracket at a desired distance from the frame.

21. A cable restraint according to claim 20 wherein the mounting arm further has a protrusion attached thereto that is received within the slot to prevent rotation of the cross bar relative to the mounting bracket.

22. A cable restraint according to claim 20 wherein the support member comprises at least one cable tie for receiving a cable wrap to secure a cable to the cross bar.

23. A cable restraint comprising:
at least one mounting bracket having a first end adapted for mounting to a frame and a second end spaced from the first end and the frame;
a cross bar;
means for connecting the cross bar to the mounting bracket such that the position of the cross bar relative to the mounting bracket and the frame is adjustable between a retracted position adjacent the first end of the mounting bracket and an extended position adjacent the second end of the mounting bracket.

24. A cable restraint according to claim 23 wherein the means for connecting comprises a slot extending between the first end of the mounting bracket and the second end of the mounting bracket, a stud attached to the cross bar that is received within the slot, and a fastener that engages the stud against the mounting bracket to secure the cross bar to the mounting bracket at a desired distance from the frame.

25. A cable restraint according to claim 23 wherein the cross bar comprises at least one cable tie for receiving a cable wrap to secure a cable to the cross bar.

26. A cable restraint according to claim 23 wherein the cross bar comprises a support member and at least one mounting arm depending therefrom and wherein the means for connecting comprises a slot extending between the first end of the mounting bracket and the second end of the mounting bracket, a stud attached to the mounting arm that is received within the slot, and a fastener that engages the stud against the mounting bracket to secure the cross bar to the mounting bracket at a desired distance from the frame.

27. A cable restraint according to claim 26 wherein the mounting arm further has a protrusion attached thereto that is received within the slot to prevent rotation of the cross bar relative to the mounting bracket.

28. A cable restraint according to claim 26 wherein the support member comprises at least one cable tie for receiving a cable wrap to secure a cable to the cross bar.

29. A cable restraint comprising:
mounting brackets having a first end adapted for mounting to a frame and a second end spaced apart from the first end and the frame;
a support member;
mounting arms spaced apart on the support member and depending therefrom, each of the mounting arms positioned adjacent a corresponding one of the mounting brackets; and
an adjustment mechanism connecting the mounting arms to the mounting brackets such that the position of the support member relative to the mounting brackets and the frame is adjustable between a retracted position wherein the cross bar is a first predetermined distance from the first ends of the mounting brackets and an extended position wherein the cross bar is a second predetermined distance from the first ends of the mounting brackets.

30. A cable restraint comprising:
a mounting bracket having a first end adapted for mounting to a frame and a second end spaced apart from the first end and the frame;
a cross bar connected to the mounting bracket; and
an adjustment mechanism for adjusting the position of the cross bar relative to the mounting bracket and the frame between a first predetermined distance from the first end of the mounting bracket and a second predetermined distance from the first end of the mounting bracket.

32. A cable restraint according to claim 30 wherein the adjustment mechanism comprises a slot formed through the mounting bracket, a stud depending from the cross bar and positioned within the slot, and a fastener that engages the stud to releasably secure the cross bar to the mounting bracket.

33. A cable restraint comprising:
a mounting bracket having a first end adapted for mounting to a frame and a second end spaced apart from the first end and the frame;
a cross bar connected to the mounting bracket; and
means for adjusting the position of the cross bar relative to the mounting bracket and the frame between a first predetermined distance from the frame and a second predetermined distance from the frame.

34. A cable restraint according to claim 33 wherein the means for adjusting comprises a slot formed through the mounting bracket, a stud depending from the cross bar and positioned within the slot, and a fastener that engages the stud to releasably secure the cross bar to the mounting bracket.

35. A cable restraint comprising:
at least one mounting bracket adapted for mounting to a frame and having a slot formed therethrough; and
a cross bar connected to the mounting bracket such that the position of the cross bar relative to the mounting bracket and the frame is adjustable within the slot of the mounting bracket.
